(19) United States
(12) Patent Application Publication
(10) Pub. No.: US 2010/0203481 A1
(43) Pub. Date: Aug. 12, 2010

(54) METHOD AND KIT FOR DELIVERING ENDODONTIC REGENERATIVE TREATMENT

(75) Inventors: Peter E. Murray, Fort Lauderdale, FL (US); Franklin Garcia-Godoy, Fort Lauderdale, FL (US)

Correspondence Address: VENABLE LLP, P.O. BOX 34385, WASHINGTON, DC, 20043-9998, US

(73) Assignee: Nova Southeastern University, Fort Lauderdale, FL (US)

(21) Appl. No.: 12/670,017

(22) PCT Filed: Dec. 12, 2008
(86) PCT No.: PCT/US2008/013699

§ 371 Date: Jan. 21, 2010

Related U.S. Application Data
(60) Provisional application No. 60/013,821, filed on Mar. 21, 1996.

(51) Int. Cl. A61C 19/06; B65D 69/00

(52) U.S. Cl. 433/224; 206/570

(57) ABSTRACT

The present invention provides novel methods and kits for removing unhealthy or necrotic pulp tissue from inside the root canals of a tooth, and to replace it with new vascularized tissue created by regenerative endodontic treatment. The present invention provides alternatives to current root canal therapies, as well as obturation of the root canal with dental materials.

### FIELD OF THE INVENTION

The present invention relates to the practice of endodontics, commonly known as root-canal therapy, which is a specialist sub-field of dentistry. Embodiments of the invention are directed to methods and kits for use in endodontic procedures.

### BACKGROUND

The practice of endodontics, commonly known as root-canal therapy, is a specialist sub-field of dentistry that deals with the tooth pulp and the tissues surrounding the root of a tooth. The pulp (containing nerves, arterioles and venules as well as lymphatic tissue and fibrous tissue) can become diseased or injured, and is often unable to repair itself. If it dies or becomes necrotic, endodontic treatment is required. “Root canal” is the commonly used term for the main canals within the dentin of the tooth. These canals are part of the natural cavity within a tooth that consists of the dental pulp chamber. Root canals are filled with a highly vascularized, loose connective tissue known as dental pulp tissue. Dental pulp tissue may become infected, diseased, and/or inflamed, generally due to dental decay or tooth fractures, thus allowing microorganisms (mostly bacteria from the oral flora or their byproducts) to access the pulp chamber or the root canals. Infected tissue is often removed by a surgical intervention known as endodontic therapy and commonly referred to as a “root canal.”

Regenerative medicine refers to the use of a combination of biomedical imaging, progenitor cells, three-dimensional scaffold materials, and suitable biochemical factors or gene therapy to improve or replace biological functions in an effort to effect the advancement of medicine. The basis for regenerative medicine is the utilization of tissue engineering therapies. In practice, regenerative medicine represents applications that repair or replace structural and functional tissues including bone, cartilage, and blood vessels, among other organs and tissues. The principles of regenerative medicine can be applied to endodontic tissue engineering, specifically, through the regeneration and revascularization of dental pulp tissue. The ability to regenerate and revascularize dental pulp tissue provides patients with a clear alternative to current root canal therapies, as well as obturation of the root canal with dental materials.

### SUMMARY OF THE INVENTION

Embodiments of the present invention provide a novel method to remove unhealthy pulp tissue from inside the root canals of a tooth, and to replace it with new vascularized tissue created by regenerative endodontic treatment.

The present invention also provides, in some embodiments, novel kits for removing unhealthy pulp tissue from inside the root canals of a tooth, and replacing it with new vascularized tissue created by regenerative endodontic treatment.

### BRIEF DESCRIPTION OF THE DRAWINGS

FIG. 1: Shows a schematic of regenerative endodontic treatment.

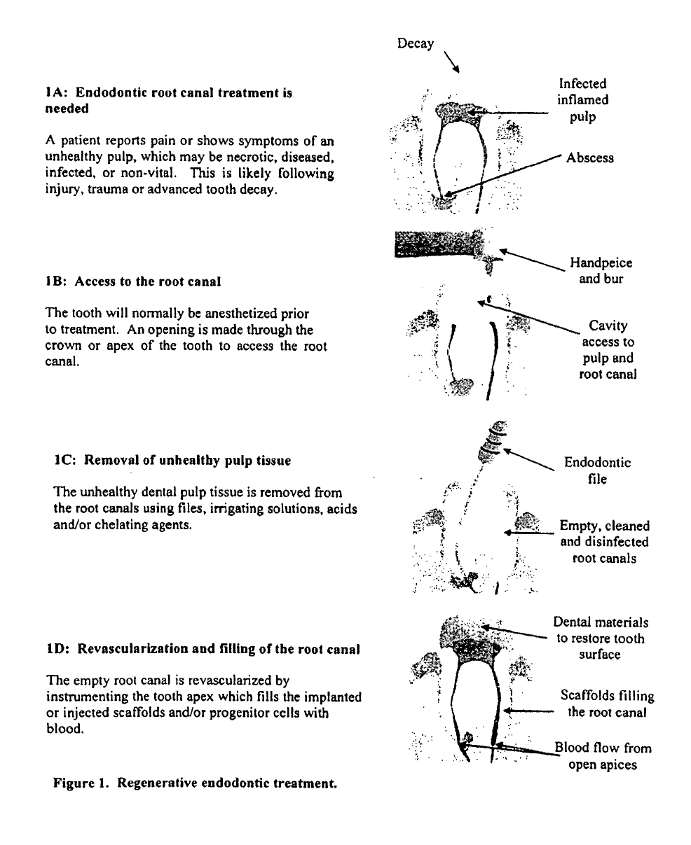

FIG. 2: Shows a flow chart of an example of the methodology for regenerative endodontic treatment.

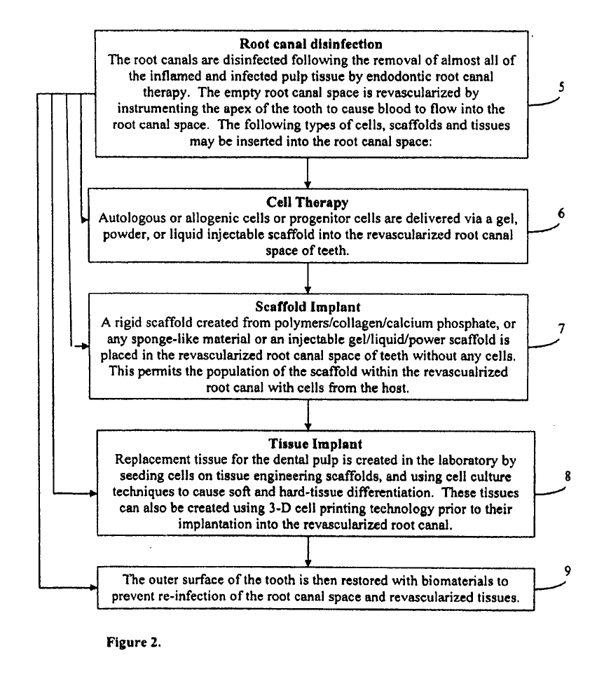

FIG. 3: Shows a flow chart describing an example of a regenerative endodontic treatment kit of the present invention.

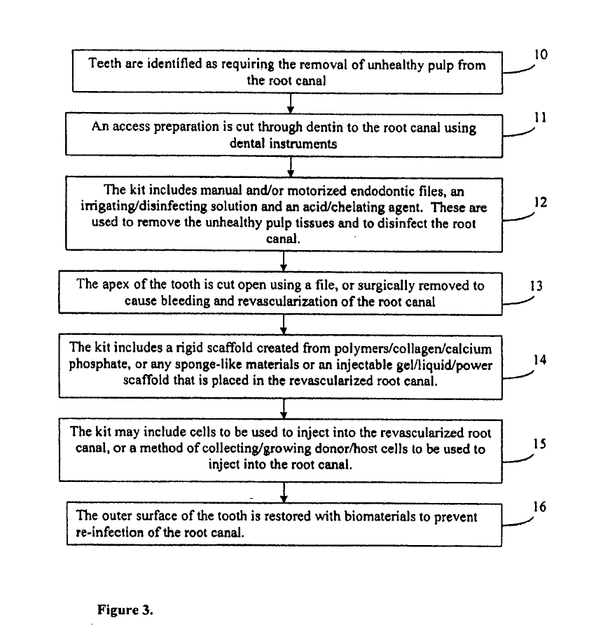

FIG. 4: Shows the creation of replacement revascularized tissues inside root canals.

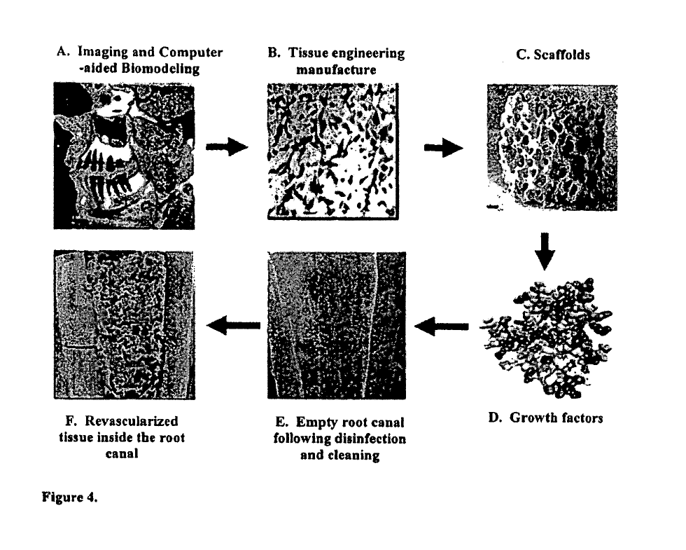

FIG. 5: Shows the biocompatibility measurements of regenerative endodontic treatment. The survival, death, attachment, and proliferation of dental pulp stem cells (A) and other types of cells including periodontal stem cells (B) can be used to test biocompatibility, and cytotoxicity of the scaffolds, files/cleaning instruments, biomaterials, disinfectants, and medicaments to be used as part of regenerative endodontic treatment shown in FIG. 1, 2 or 3. Prior to in vivo clinical or animal testing, these procedures may be tested using in vitro extracted teeth and cell culture techniques.

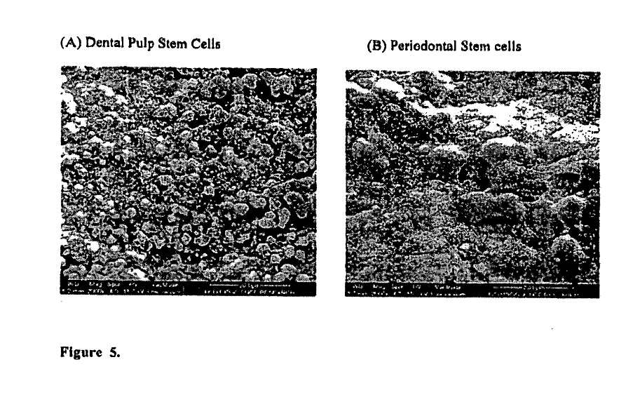

FIG. 6: Shows the efficacy measurements of regenerative endodontic treatment. The efficacy of regenerated tissues within the root canal of in vivo teeth can be measured using non-invasive methods such as Doppler measurements of blood flow and electrical pulp vitality testing. In the case of clinical trials, patients may be asked to rate the success of the treatment. The teeth may also be extracted for assessment of tissue regeneration associated with the revascularized root canals. Alternatively, extracted teeth may be subject to various aspects of endodontic tissue regeneration to measure the in vitro efficacy of the regenerative endodontic procedures prior to their clinical or animal testing. The measurement methods include cell survival assays, as well as adherence to root canal surfaces, using scanning/transmission electron microscopy, and histology. The image below shows the efficacy testing of a collagen scaffold seeded with dental pulp stem cells to create a dental pulp construct implanted into a root canal following the removal of pulp tissues, and its disinfection. Adherence was observed between the implanted scaffold containing stem cells and the root canal surface (A). Stem cells remained attached to the scaffold for up to 14 days in culture (B). The histology of the replacement pulp cells within the scaffold was found to be actively metabolizing (C) suggesting the construct was vital.

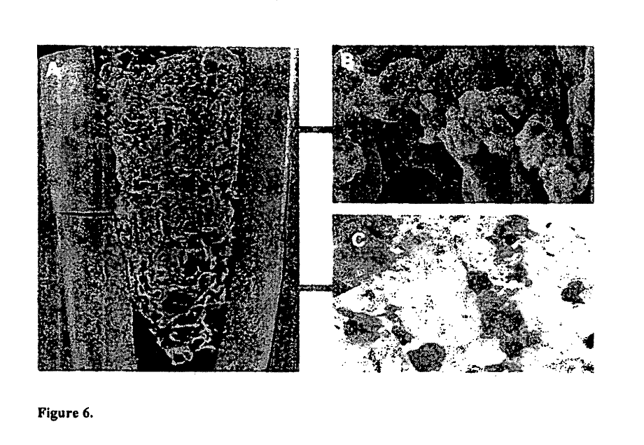

FIG. 7: Shows the sourcing, banking and delivery of stem cells and scaffolds for use in regenerative endodontic treatment.

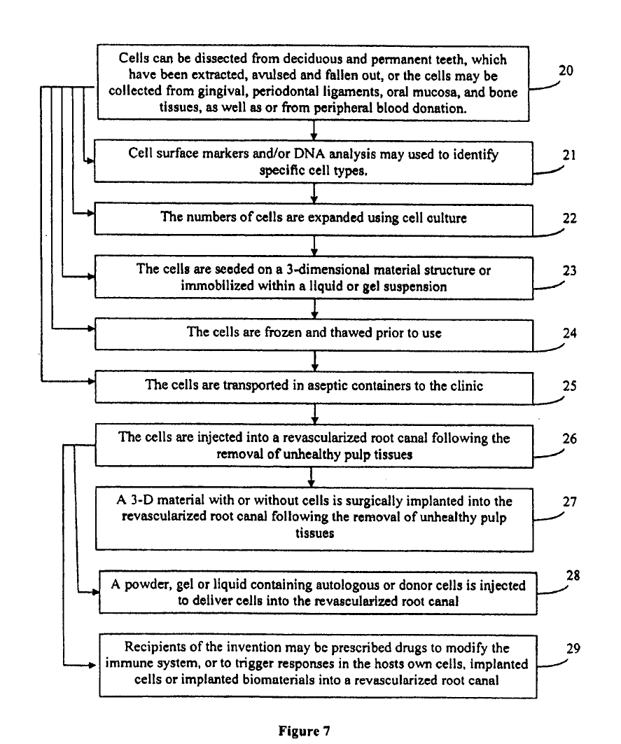

FIG. 8: A dental pulp stem cell bank for regenerative endodontic treatment.

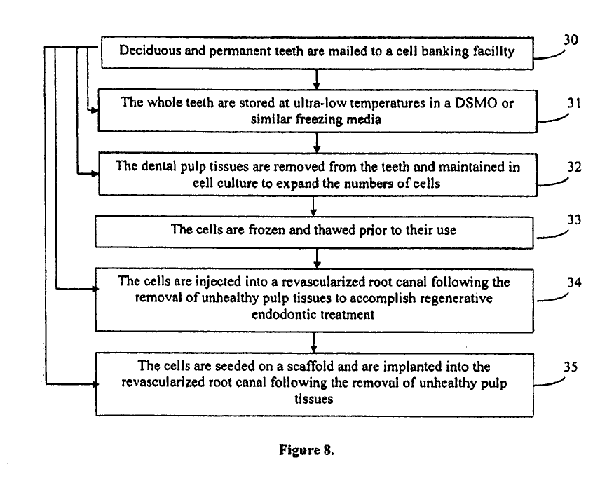

FIG. 9: Shows cell repopulation and tissue regeneration within a revascularized tooth root canal containing a collagen scaffold.

FIG. 10: Shows cell repopulation and tissue regeneration within a revascularized tooth root canal containing P15 Pepgen.

FIG. 11: Shows cell repopulation and tissue regeneration within a revascularized tooth root canal containing a blood clot.

FIG. 12: Shows cell repopulation and tissue regeneration within the root canals of teeth following regenerative endodontic treatments.

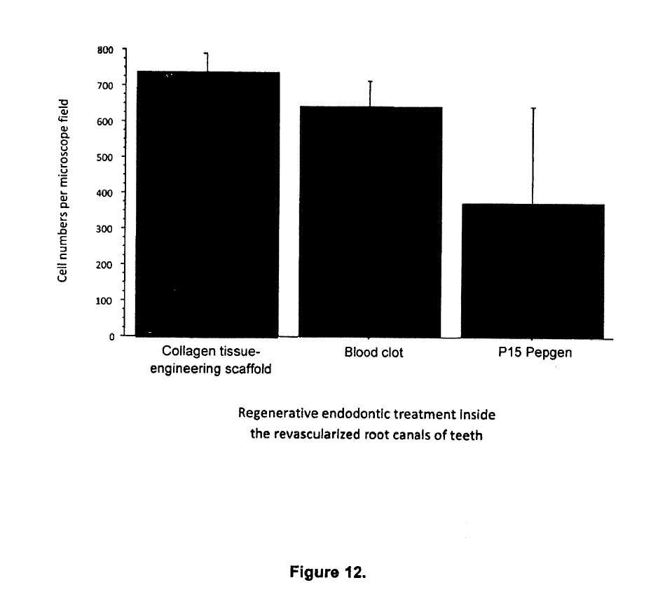

FIG. 13: Shows cell repopulation of revascularized root canals following regenerative endodontic treatments.

### DETAILED DESCRIPTION OF THE INVENTION

The present invention describes methods, compositions, devices and kits to disinfect, clean, and revascularize the root canals of in vivo, ex vivo, or re-implanted teeth, following the removal of unhealthy or necrotic pulp tissue.

In some embodiments, the present invention may be used as a direct replacement or alternative to the use of gutta percha, mineral trioxide aggregate, and/or dental cements that are currently used as root canal obturation materials in endodontic treatment.

These and other aspects of the present invention are presented in more detail below. The headings used to follow are for organizational purposes only and are not intended to impart any division to the document or meaning unless specifically indicated.

Endodontic Methods

In an embodiment, the present invention provides a method of removing unhealthy pulp tissue from inside the root canals of a tooth, and replacing it with new vascularized tissue created by regenerative endodontic treatment. This method can include any or all of the following steps: (a) creating an access opening to the root canal system; (b) removing unhealthy or necrotic dental pulp tissue from the root canal system; (c) cleaning and disinfecting the root canal system; (d) causing blood to flow into the root canal system by instrumenting the apex; and (e) inserting into the root canal system a scaffold (e.g., rigid or injectable) that can have progenitor dental pulp cells and/or growth factors. As used herein. root canal instrumentation means the controlled removal of dentin and pulp tissues using dental instruments, normally endodontic files and/or ultrasonic tips in combination with irrigating solutions (e.g., NaOCl) and optionally with smear layer removal agents (e.g, EDTA).

Optionally, the methods described herein can include applying a post-operative sealant to the coronal and/or apical access to the root canal to help prevent infection.

Preparation of the Tooth

Teeth are identified as requiring root canal treatment to remove unhealthy or necrotic pulp tissues. The tooth can be anesthetized prior to surgery. An opening is made through the crown or apex of the tooth to access the root canal. An access preparation can also be made through the dentin to the root canal using a dental hand-piece and bur. The unhealthy or necrotic dental pulp tissue is then removed from the root canals using, for example, a file, irrigating solutions, acids, chelating agents, and/or any suitable equivalent thereof. The root canals are then disinfected following the removal of almost all of the necrotic pulp tissue by endodontic root canal therapy.

Revascularization

In some embodiments, the methods described herein include revascularization. Revascularization is a surgical procedure for the provision of a new, additional, or augmented blood supply to the root canal. Revascularization has several advantages. The procedure is technically simple and can be completed using currently available instruments and medicaments without expensive biotechnology. Moreover, the regeneration of tissue in root canal systems by a patient's own blood cells avoids the possibility of immune rejection and pathogen transmission from replacing the pulp with a tissue engineered construct. Furthermore, enlargement of the apical foramen not only promotes vascularizaton but can also maintain initial cell viability via nutrient diffusion.

In another embodiment of the present invention, after the necrotic root canal system has been cleaned and disinfected, the root canal system is revascularized by establishing bleeding into the canal system via over-instrumentation. In an embodiment, instrumenting the tooth apex causes blood to flow into the root canal. In another embodiment, the use of intracanal irrigants (NaOCl and chlorhexidine) in conjunction with antibiotics (e.g., a mixture of ciprofloxacin, metronidazole, and minocycline paste) for several weeks disinfects root canal systems and increases revascularization of avulsed and necrotic teeth.

Re-implantation of avulsed and/or necrotic teeth with an apical opening of approximately 1.1 mm can have a greater likelihood of revascularization. Revascularization of necrotic pulps with fully formed (“closed”) apices may require instrumenting the tooth apex to approximately 1-2 mm in apical diameter to allow systemic bleeding into root canal systems.

Progenitor Cells

The methods of the present invention can involve the addition of progenitor cells, optionally, while implanting the scaffold described below into a patient. Dental pulp contains a progenitor cell population referred to as pulp stem cells, or in the case of immature teeth, stem cells from human exfoliated deciduous teeth (SHED). Pulp stem cells are also referred to as odontoblastoid cells because these cells appear to synthesize and secrete dentin matrix like the odontoblast cells they replace. Following severe pulp damage or mechanical or caries exposure, the odontoblasts are often irreversibly injured beneath the wound site. Odontoblasts are post-mitotic terminally differentiated cells, and cannot proliferate to replace subjacent irreversibly-injured odontoblasts. Pulp stem cells for the odontoblastoid cells are resident, undifferentiated mesenchymal cells. The origins of these cells may be related to the primary odontoblasts because during tooth development, only the neural crest derived cell population of the dental papilla is able to specifically respond to the basement membrane-mediated inductive signal for odontoblast differentiation. The ability of both young and old teeth to respond to injury by induction of reparative dentinogenesis suggests that a small population of competent pulp stem cells may exist within the dental pulp throughout life.

Progenitor cells can be identified and isolated from mixed cell populations by using, for example, four techniques: i) Staining the cells with specific antibody markers and using a flow cytometer in a process called fluorescent antibody cell sorting (FACS); ii) immuno-magnetic bead selection; iii) immuno-histochemical staining; and iv) physiological and histological criteria, including but not limited to, phenotype (appearance), chemotaxis, proliferation, differentiation and mineralizing activity. FACS together with the protein marker CD34 is widely used to separate human stem cells expressing CD34 from peripheral blood, umbilical cord blood, and cell cultures. Different types of progenitor cells often express different proteins on their membranes and are therefore not identified by the same progenitor cell protein marker. The most studied dental progenitor cells are pulp stem cells. Human pulp stem cells express von Willebrand factor CD146, alpha-smooth muscle actin, and 3G5 proteins. Human pulp stem cells also have a fibroblast phenotype, with specific proliferation, differentiation and mineralizing activity patterns.

In one embodiment of the present invention, progenitor dental pulp cells from autologous (the patient's own) cells are derived from a buccal mucosal biopsy. In another embodiment, pulp stem cells are derived from an allogenic purified pulp stem cell line that is disease and pathogen-free. In yet another embodiment, the pulp stem cells are derived from xenogenic (animal) pulp stem cells that have been grown in the laboratory.

In another embodiment, progenitor cells from autogenous cells are derived from umbilical cord stem cells that have been cryogenically stored after birth. Autogenous stem cells are relatively easy to harvest, easy to deliver by syringe, and the cells have the potential to induce new pulp regeneration. The use of autogenous human pulp stem cell line is also advantageous because the patient does not need to provide their own cells through a biopsy. Moreover, purification and expansion of cell number would permit collection of smaller tissue biopsies—although the patient will still have to wait some time before the cells have been purified and/or expanded in number.

In another embodiment of the present invention, progenitor dental pulp cells are sourced from extracted or in situ deciduous or permanent teeth, and surrounding oral tissues. The progenitor dental pulp cells can be collected from dental tissues including, but not limited to, dental pulp, periodontal, apical papilla or cementum tissues, by growing the cells in cell culture or using a cell sorting technique by stem cell markers. The dental tissues are prepared for cell culture by enzymatic digestion, or disaggregated by mechanical instrumentation. The tissues are then dried onto cell culture plates, or immobilized under a solid glass or plastic cover-slip. The tissues are submerged in a nutrient cell culture media, with or without bovine serum or synthetic substitute at a concentration, for example, of between 1 and 50%, and maintained in an incubator at a temperature, for example, of 37° C. and a 1-10% CO₂ atmosphere.

The cell cultures, in some embodiments, can optionally be treated with a number of additives as needed. For example, antibiotics and antifungal agents can be added to avoid infection of the cell cultures. Vitamin C and L-glutamine can also be added to the culture media to provide essential proteins. Bioactive molecules, for example growth factors, can also be added to the culture media.

After the cells have reached confluence they can be harvested from the culture dishes using, for example, trypsinization with or without EDTA, centrifuged, and re-suspended in cell culture plates with cell culture media. At any time, the harvested cells may be suspended in freezing media, for example, comprising 10% DMSO in bovine serum, or synthetic serum, or cell culture media. The cells in the freezing media can be slowly frozen in small aliquots, and placed into ultra-low temperature freezers for storage, or placed and stored in a tank containing liquid nitrogen. In another embodiment, each aliquot of cells is marked with a code to link them to the donor, or to identify any information about the donor. The cells may be removed from storage at any time and grown in culture to ensure the viability of the cells. In another embodiment the frozen aliquots are thawed every year, or every few years.

If the cells have been frozen, at such a time when the cells are needed to be used as part of regenerative dental treatment to regenerate missing, lost, diseased, damaged, or injured teeth, bone or soft tissues, the cells are removed from frozen storage, suspended in culture media, and maintained in an incubator until they reach confluence. If the cells are already in culture, they are grown until they reach confluence. The confluent cells are re-plated to expand the total numbers of cells. In another embodiment of the present invention, once sufficient numbers of cells have been produced, they are harvested through, for example, trypsinization and seeded on three dimensional biomaterials commonly known as tissue engineering scaffolds.

Three Dimensional Constructs

In another embodiment of the present invention, progenitor dental pulp cells are organized into a three-dimensional scaffold that can support cell organization and vascularization. This can be accomplished using a porous polymer scaffold seeded with progenitor dental pulp cells to create a dental pulp construct. The cells are seeded on the scaffolds and are immediately implanted into the oral tissue of humans or animals, or, in another embodiment, the cell and scaffold constructs may be maintained in cell culture for days, weeks, and even months prior to implantation into the oral tissues of humans or animals.

The tissue scaffolds can be created in uniform sizes, colors, and/or shapes. In the case of teeth, the synthetic constructs may be created in a range of naturally occurring tooth sizes, tooth colors and tooth shapes. In the case of dental pulp, periodontium, cementum, enamel, bone, and/or oral mucosa tissues, the size, thickness and appearance of the tissues can be determined by the size, shape and properties of the tissue engineering scaffold.

In some embodiments, the scaffold can be coated with one or more of the following: hydroxylapatite (hydroxyapatite); cell adhesion molecules; extracellular matrix proteoglycan matrix components such as heparin sulfate proteoglycans, chondroitin sulfate proteoglycans, keratin sulfate proteoglycans; or non-proteoglycan matrix components such as laminin, hyaluronic acid, collagen, fibronectin, and elastin.

In one embodiment, the scaffold is further comprised of nutrients promoting cell survival and growth, as well as antibiotics to prevent any bacterial in-growth in the root canal systems. In addition, the scaffold may exert essential mechanical and biological functions needed by a replacement tissue. For example, in teeth where pulp is exposed, dentin chips have been found to stimulate reparative dentin bridge formation. Accordingly, in another embodiment of the present invention, dentin chips may provide a matrix for progenitor dental pulp cell attachment and also serve as a reservoir of growth factors.

In some embodiments, the scaffold is biodegradable so that it may be absorbed by the surrounding tissues without the necessity of surgical removal. In some embodiments, the scaffold has a high porosity and an adequate pore size to facilitate cell seeding and diffusion throughout the whole structure of both cells and nutrients.

The rate at which scaffold degradation occurs can, in some embodiments, coincide with the rate of tissue formation near the scaffold. In other words, while cells are fabricating their own natural matrix structure around themselves, the scaffold should be able to provide structural integrity. Likewise, around the time when the newly formed tissue has developed to the point where it can independently carry the mechanical load, the scaffold should begin to break down.

The scaffolds of the present invention can be made of natural or synthetic materials that are either biodegradable or permanent. Common synthetic materials include, but are not limited to, gelatin, polylactic acid (PLA), polyglycolic acid (PGA), and polycaprolactone (PCL), which are all common polyester materials that degrade within the human body. These scaffolds have all been successfully used for tissue engineering applications because they are degradable fibrous structures with the capability to support the growth of various different progenitor cell types.

Scaffolds may also be constructed from natural materials, including but not limited to several proteic materials such as collagen, calcium phosphate, fibrin, and polysaccharidic materials like chitosan or glycosaminoglycans (GAGs). Most of these scaffold materials are biocompatible and biodegradable to allow new tissues to regenerate inside the root canal. However, certain scaffold materials such as polytetrafluoroethylene (PTFE) are permanent non-degradable scaffold materials and will remain in the root canal.

In one embodiment of the present invention, a rigid tissue engineering scaffold structure may assist with the organization and vascularization of progenitor dental pulp cells in the root canal system. In another embodiment, tissue engineered pulp tissue is administered in a soft three-dimensional scaffold matrix such as a polymer hydrogel, gelatin, and agar-based gels. Hydrogels and other gel-based formulations are injectable scaffolds that can be delivered by syringe. One advantage of injectable scaffolds is that they are non-invasive and easy to deliver into root canal systems. In yet another embodiment, the injectable scaffold is photopolymerizable, or able to form rigid structures once implanted into the desired tissue site.

In another embodiment, the tissue constructs may be designed by computer software using data collected from radiographs, and/or magnetic resonance images, and/or micro-CT x-ray tomography to precisely fit a single or multiple recipient sites in a human or animal.

In yet another embodiment, the three-dimensional scaffolds are surgically implanted into humans or animals, without seeding progenitor cells on these scaffolds in vitro or in situ prior to implantation. Instead, the recipients of the scaffolds are given medicaments containing pharmaceutical compounds (e.g., drugs, biologics, or adjuvants) which activate and mobilize the host recipients own progenitor cells to colonize the scaffold and regenerate the lost, missing, diseased, or injured dental tissues.

Growth Factors and Molecular Control of Cell Migration

Another embodiment of the methods of the present invention includes providing effective therapies for stimulating revascularization and regeneration of tissue within the root canal. These methods can involve administering a growth factor to the patient or a compound capable of stimulating growth factor production.

For example, dentin (e.g., in a chip form) can be used to stimulate a growth factor response in the patient. Dentin contains many proteins capable of stimulating tissue responses. Once released, these growth factors can play key roles in signaling many of the events of tertiary dentinogenesis, a response of pulp-dentin repair. Growth factors, especially those of the transforming growth factor-beta (TGFβ) family, are important in cellular signaling for odontoblast differentiation and stimulation of dentin matrix secretion. These growth factors are secreted by odontoblasts and deposited within the dentin matrix where they remain protected in an active form through interaction with other components of the dentin matrix. The addition of purified dentin protein fractions can also stimulate an increase in tertiary dentin matrix secretion.

Another important family of growth factors in tooth development and regeneration are the bone morphogenic proteins (BMP's). Recombinant human BMP2 stimulates differentiation of adult pulp stem cells into an odontoblastoid morphology in culture. The similar effects of TGF B1-3 and BMP7 have been demonstrated in cultured tooth slices. Recombinant BMP-2, -4, -7 induce formation of reparative dentin in vivo. The application of recombinant human insulin-like growth factor-1 together with collagen has been found to induce complete dentin bridging and tubular dentin formation. Accordingly, in some embodiments, a BMP can be administered as part of the methods described herein.

Another embodiment of the present invention includes the use of pharmaceutical compounds in the methods described herein to facilitate directional migration of progenitor cells. Directional migration of progenitor cells or stem cells can be necessary for embryonic development as well as for homeostatic maintenance and repair of injured organs and tissues in adults. For example, in the absence of migration, the contribution of progenitor cells to the development of functional organs and tissues would not be possible, as all progenitor cells must migrate to sites where they are required to function.

The Rho family of GTPases constitute a family of intracellular messengers that are regulated both by their location and state of activation. They exert important influences in almost all functions of the progenitor cell, including adherence and migration. For example, Rho exerts important effects on cellular contraction and detachment, while Rac exerts effects needed for directed migration of polarized cells. Cdc42 activates many of the same receptors as Rac, but its effects appear limited to those involving cellular morphology and lamillopodia development. Studies have demonstrated Rac at the leading edge of migrating cells where Rho in fact is either inactivated or disintegrated. Conversely, at the tailing edge of migrating stem cells, activated Rho associates with its effector Rho kinase, Pak-1. The kinase activity of Pak-1 is enhanced when it engages Rac in its GTP “activated” form.

In the nucleus, the tumor suppressor protein p27 kip binds with its amino-terminal region (N) to complexes of cyclins and cyclin-dependent kinases (CDKs), thus inhibiting cell proliferation. When phosphorylated (P), p27 kip 1 is believed to move into the cytoplasm, where as shown by Besson et al., it binds through its carboxy terminus (C) to RhoA and interfaces with RhoA activation by guanine-nucleotide-exchange factors (GEFs). RhoA, Cdc42, and Rac regulate the cytoskeletal changes required for cell migration. Cdc42 and Rac work mainly at the front of polarized cells, regulating the actin-driven protrusion and the formation of new adhesions required for forward movement. RhoA, through the ROCK protein, works mainly at the rear, determining (among other processes) the turnover of adhesive sites known as focal adhesions and thereby rear retraction. By interfering with RhoA activation, FAK inhibits or promotes cell migration, depending on the cell type.

In some embodiments, the migration of progenitor dental pulp cells can be controlled by a balance in Rac/Rho-kinase activation. When Rac is activated the cell migrates forward, when Rho-kinase is activated the cell remains fixed in position. Accordingly, in one embodiment of the present invention, drug therapies can be targeted and delivered to the Rho family of GTPases in order to control progenitor dental pulp cell migration as part of tissue engineering therapy described herein.

Biocompatibility and Efficacy Measurements of Regenerative Endodontic Treatment

In another embodiment of the present invention, the survival, death, attachment, and proliferation of pulp stem cells and other types of progenitor cells including periodontal stem cells can be used to test biocompatibility and cytotoxicity of the scaffolds, files/cleaning instruments, biomaterials, disinfectants, and medicaments to be used as part of regenerative endodontic treatment described herein. Prior to in vivo clinical or animal testing, these procedures can be tested using in vitro extracted teeth and cell culture techniques or assays.

In another embodiment of the present invention, the efficacy of regenerated tissues within the root canal of in vivo teeth can be measured using non-invasive methods such as Doppler measurements of blood flow and electrical pulp vitality testing. In the case of clinical trials, patients can be asked to rate the success of the treatment based on qualitative or quantitative characteristics of interested to the researchers.

The teeth may also be extracted for assessment of tissue regeneration associated with the revascualrized root canals. Alternatively, extracted teeth may be subject to various aspects of endodontic tissue regeneration to measure the in vitro efficacy of the regenerative endodontic procedures prior to their clinical or animal testing. The measurement methods include cell survival assays, as well as adherence to root canal surfaces, using scanning/transmission electron microscopy, and histology.

Endodontic Kits

The present invention is also directed to kits for use in the methods described herein as well as for use in other suitable dental applications. The kits can include any of the example components described as part of the above methods as well as those components described to follow.

In some embodiments of the present invention, the scaffold (also referred to herein as an “implantable matrix”) may be included in a kit that allows a practitioner to deliver comprehensive regenerative endodontic treatment. These kits can further comprise any or all of the following: disinfecting solution, isolated dental pulp cells, or endodontic files. The kit can, for example, have a scaffold, manual and/or motorized endodontic files, an irrigating/disinfecting solution and an acid/chelating agent is utilized to clean the necrotic pulp tissues and to disinfect the root canal.

In some embodiments, the implantable matrix in the kit can be a hydrogel packaged for use in the methods described herein. The implantable matrix in the kit can be composed at least partially of any of the following materials: collagen, fibrin, chitosan, glycosaminoglycans, and mixtures thereof. The implantable matrix in the kit can be composed at least partially of any of the following materials: polylactic acid, polyglycolic acid, polycaprolactone, and mixtures thereof. The implantable matrix in the kit can be composed at least partially of platelet rich plasma, blood, or any blood serum product.

In some embodiments, the kit contains an antibiotic. The antibiotic can be, for example, part of the implantable matrix or separately packaged within the kit.

In some embodiments, the kit contains stem cells or other isolated dental pulp cells. These cells can, in some embodiments, express at least one of the following: von Willebrand factor CD146, alpha-smooth muscle actin, and 3G5 proteins.

The kits of the present invention can also contain a cellular growth factor selected from the group consisting of a member of the transforming growth factor-beta family, a bone morphogenic protein, insulin-like growth factor-I or -II, Colony stimulating factor, Epidermal growth factor, Fibroblast growth factor, Insulin-like growth factor-I or II, Interleukins IL-1 to IL-13, Platelet-derived growth factor, and Nerve growth factor.

Other features of the invention will become apparent in the course of the following descriptions of exemplary embodiments that are given for illustration of the invention and are not intended to be limiting thereof.

### Example 1

### Cleaning and Shaping of Teeth

Human subjects are enrolled or extracted teeth are used following institutional review board approval. The teeth are prepared for routine endodontic treatment. The root canal working length is achieved by subtracting 1 mm from the length at which a 15 K-file (Dentsply Tulsa Dental, Tulsa, Okla.) was visualized at the apical foramen. The teeth are cleaned and shaped using Protaper and ProFile rotary instruments (Dentsply Tulsa Dental, Tulsa, Okla.). The root canals are instrumented using the following sequence of files: SX, S1, S2, F1, F2, F3, and 35/0.06. During cleaning and shaping, 1 ml of 6% sodium hypochlorite [Na0Cl] (Clorox, Oakland, Calif.) irrigating solution is used after each instrument size. A total of 6 ml of irrigation solution is used during the biomechanical preparation using small plastic needles (Ultradent Products, South Jordan, Utah, USA). This was followed by the application of 3 ml of 17% EDTA (PulpDent, Watertown, Mass.) for 1 minute, and by a final flush with 6 ml 6% Na0Cl.

Disinfection of Teeth

The teeth are disinfected by submerging them in 6% NaOCl (Clorox, Oakland, Calif.) for 5 minutes. The specimens are then washed in sterile saline and re-washed two additional times. The instrumented teeth are maintained in Hanks Balanced Salt Solution (HBSS, BD Biosciences, Franklin Lakes, N.J.) for up to three days at 5° C.

Progenitor Dental Pulp Cells

Progenitor dental pulp cells are cells are obtained from human exfoliated deciduous (SHED) teeth collected from volunteer patients and frozen prior to use. The cells are cultured in Dulbeccos Modified Eagles Medium (DMEM, BD Biosciences, Franklin Lakes, N.J.). Cell cultures are maintained at 37° C. in a humidified atmosphere of 5% CO₂ with the culture media being replenished every second day for up to 60 days. Confluent cell cultures are collected by trypsinization (0.25% trypsin/EDTA, Mediatech, Inc., Herndon, Va.).

Implantation of Dental Pulp Tissue Constructs into Cleaned and Shaped Teeth

Three types of 3-dimensional scaffolds were investigated: Open-cell polylactic acid (OPLA), Calcium phosphate, and collagen scaffolds created from bovine hide (BD Biosciences, Bedford, Mass.). Each cylindrical scaffold is sliced into two pieces to provide a scaffold with an approximate length of 5 mm and a width of 2 mm, and an estimated volume of 0.01195 cm³. The scaffolds are soaked in neutral phosphate buffered saline (PBS) and stored at 5° C. Twenty-four hours prior to cell seeding, the PBS is replaced by DMEM.

The first two treatments groups are controls. Group 1 comprising cleaned and shaped root canals without any scaffolds or cells, and Group 2 comprising SHED×10⁶ injected into the cleaned and shaped root canals of fifteen teeth without any scaffold. The remaining groups comprised the experimental treatment groups. Group 3 comprising the OPLA scaffold is incubated at 37° C. for 30 minutes before application of the cells to equalize the culture conditions. Dental pulp constructs are created by seeding SHED×10⁶ in each of OPLA scaffolds using a sterile micro-syringe, twenty four hours prior to implantation. The constructs are then implanted into the root canals of fifteen cleaned and shaped teeth using sterile forceps and endodontic pluggers (Miltex Inc., York, Pa.). Group 4, comprising the same scaffold as Group 3, except the scaffolds are manufactured from bovine collagen. Group 5, comprising the same scaffold as Group 3, except the scaffolds are manufactured from Calcium phosphate. Group 6, comprising the same scaffold as Group 3, except that 50 ng of BMP-2 is added to each scaffold in 50 μl of 0.1% Bovine serum albumin (BSA) in PBS pH 7.4. Group 7, comprising the same scaffold as Group 3, except that 50 ng of TGF-β1 (Sigma-Aldrich, St Louis, Mo.), is added to each scaffold in 50 μl of 0.1% BSA in PBS pH 7.4. Group 8, comprising the same scaffold as Group 3, except that 50 ng of 13-glycerophosphate is added to each scaffold in 50 ml of 0.1% BSA in PBS pH 7.4. All the teeth containing cells, scaffolds and dental pulp constructs are submerged in 1 ml of DMEM culture media and maintained in 24-well culture plates (BD Biosciences, Bedford, Mass.) for 1, 7, or 14 days.

Preparation for Scanning Electron Microscopy

The teeth are fixed by submerging them in a 10% neutral-buffered formalin solution at 18° C. for 24 hours. The teeth are then postfixed in osmium tetroxide (1% v/v) for 2 hours before being dehydrated in a graded series of ethanol solutions; 80%, 90%, 95% for 15 minutes each, followed by 3×10 minutes of 100% ethanol. The teeth are removed from the solutions and placed in hexamethyldistilazane for 5 minutes to fix the dehydrated specimens. The teeth are prepared for visualization in the scanning electron microscope (SEM) by fracturing them into two-halves along the longitudinal axis using a chisel. The teeth are dried on filter paper for 30 minutes. The tooth specimens are mounted onto aluminum stereoscan stubs with rapid set Araldite (Devcon Ltd, Shannon, Ireland). The dried mounted specimens are coated with a 20-30 nm thin metallic layer of gold/palladium in a Cressington Sputter Coater model 108Auto (Watford, U.K.)

Scanning Electron Microscopy of Tissue Engineered Tissues

The specimens are viewed in a Quanta 200 SEM (FEI, Hilsboro, Oreg.). SEM micrographs are obtained at ×2,000 magnification using digital image analysis software. Each of the root canals is scanned in its entirety to obtain an overview of the general surface topography. Cell attachment is visualized within the dental pulp constructs and to root canal dentin using micrographs. The effectiveness of the tissue engineered dental pulp constructs to adhere to the root canals is assessed using semi-quantitative criteria.

### Example 2

Fourteen (n=14) maxillary teeth in an M. fascicularis non-human primate were instrumented using standard endodontic techniques to an apical ISO size 40. Within the empty root canal spaces, we attempted three different regenerative treatments: Firstly, we implanted P15-Pepgen a bone regeneration material. Secondly, we implanted a collagen tissue-engineering scaffold of the present invention. Thirdly, we stimulated a blood clot by probing the apex with a #15 K-file.

After 7 days the non-human primate was sacrificed and the teeth were processed for histology, and the teeth were viewed under a light microscope ×200. The collagen scaffolds attracted the most white blood cells into the root canal spaces, and the cells had an even distribution. The P15-Pepgen bone regeneration material attracted fewer white blood cells In the P15-Pepgen is a solid granular material with a gel binder; however, the white blood cells were on the periphery not within the scaffold. By comparison the blood clot had the fewest cells in the root canals. These results demonstrate that the implantation of tissue engineering scaffolds and bone augmentation materials can be more optimal than blood clots to accomplish tissue regeneration within root canals.

2. Materials and Methods

2.1. Animal Use

Routine endodontic root canal therapy was performed on all the anterior and premolar (palatal canal) and molar (palatal canal) teeth of one M. fascicularis non-human primate aged approximately 7 years of age. The animal was given general anesthesia during surgery and analgesics following surgery to minimize and pain or stress associated with the dental procedures.

2.2. General Anesthesia

The M. fascicularis non-human primate was anesthetized with 10-15 mg/kg ketamine and maintained with isoflurane at a concentration of 1.5%. The monkey was intubated during the dental procedures. The heart rate, respiratory rate and toe pinch reflex (deep pain assessment) were monitored during the procedures.

2.3. Dental Treatment

The non-human primate teeth were treated according to the same procedures commonly applied in clinical dental practice. Each tooth was radiographed for a comparison of pre-treated versus post-treated changes in the root canal. A rubber dam anchored with rubber dam clamps was used and the surgical field was disinfected with 2% clorohexidine. A dental hand piece was used to cut a pulp chamber access cavity in the crown of each tooth. A water-spray was used to cool the tooth during access cavity cutting.

2.4. Root Canal Instrumentation and Irrigation

Small endodontic files were used to instrument the teeth using a combination of a passive step back technique, Protaper and Profile GTX rotary instrumentation (Tulsa Dentsply, Tulsa, Okla.) to a size 40.04. During cleaning and shaping 5 ml of irrigating solution (6% NaOCl, Clorox, Oakland, Calif.) was used after each instrument size. In all groups, a total of 25-30 ml of irrigation solution was used during the biomechanical preparation using small plastic needles (Ultradent Products, South Jordan, Utah). This was followed by the application of 2 ml of etchant (17% EDTA; PulpDent, Watertown, Mass.) for 15 seconds. This was followed by a final flush with 10 ml of irrigating solution for 15 seconds. The canal also received a final flush of 10 ml of sterile saline with ultrasonic activation.

The tooth apex was instrumented using #15 K-file to cause bleeding into the cleaned root canal system. As shown in Table 1 below, the teeth were randomly divided into the three different treatment groups: 1. A blood clot was allowed to form in the root canal system of three (n=3) teeth as a positive control, without any scaffold or filling materials being inserted. 2. A bovine collagen tissue-engineering scaffold (BD Biosciences, Franklin Lakes, N.J.) was inserted into the cleaned root canal system of six (n=6) teeth. 3. An injectable scaffold called P15-pepgen (Dentsply Friadent, Mannheim, Germany) was inserted into the cleaned root canal system of five (n=5) teeth. The scaffolds or blood clots in each of the treatment groups had 4 mm of MTA placed as a biocompatible base, prior to final restoration with a self-cure glass ionomer (Fuji II, GC, Tokyo, Japan).

TABLE 1
Treatment groups and numbers of regenerated teeth

| Treatment | | Post-operative interval/number of teeth (n) |
|---|---|---|
| # | Treatment group | 7 days |
| 1 | Blood clot | n = 3 |
| 2 | Collagen scaffold | n = 6 |
| 3 | P15-Pepgen | n = 5 |

2.5. Euthanasia

A M. fascicularis non-human primate was euthanized at 7 days to harvest the tissues for histological analysis.

2.6. Collection and Histological Processing of Tissues

The harvested tissues were processed for light microscope histology. The extracted teeth were fixed with 4% paraformaldehyde for 24 hours and demineralized using demineralizing solution (VWR Sewane, Ga.). After washing, the teeth were dehydrated in a graded series of alcohols (70%, 80%, 90%, 95% for two hours each), followed by two hours of 100% ethanol and then embedded in paraffin wax blocks and cut into 5 micron slices with a microtome. The histological slices of teeth were collected on glass slides and maintained at 65° C. for 12 hours. The slides were stained with hematoxylin and eosin stain using the following protocol: Xylene (3 minutes), xylene and 100% alcohol (50/50, dip), 95% ethanol (3 minutes), 70% methanol (1 minute), water (1 minute), hematoxylin (2 minutes), running water (dip), acid alcohol (dip), water (dip), 13% ammonia (dip), running water (5 minutes), 80% ethanol (dip), eosin (15 seconds), 95% ethanol (3 dips), 100% ethanol (3 minutes), and xylene (1 minute or until fixed on slides). The tissues were sealed onto the glass slides with cover-slips applied with Sure-Mount adhesive (Triangle Biomedical Sciences, Durham, N.C.).

2.7. Histology of Cells within Root Canals

The numbers of cells within the root canals of teeth delivered by the host immune response were counted per microscope field and examined the type of cell and their proportional amount of 1) Nucleated cells, 2) Non-nucleated cells. The location of the nucleated cells within the root canals using the criteria: 1) No cells, 2) Peripherally located, 3) Centrally located, and 4) Evenly distributed.

2.8. Statistical Analysis

The raw data from all the experiments was examined using analysis of variance (ANOVA) tests, and finally Scheffes post hoc procedure (Scheffe 1953) claimed to be versatile and the most conservative multiple comparison test (Dawson-Saunders and Trapp 1994).

3. Results

3.1. Cell Numbers within Regenerated Root Canals

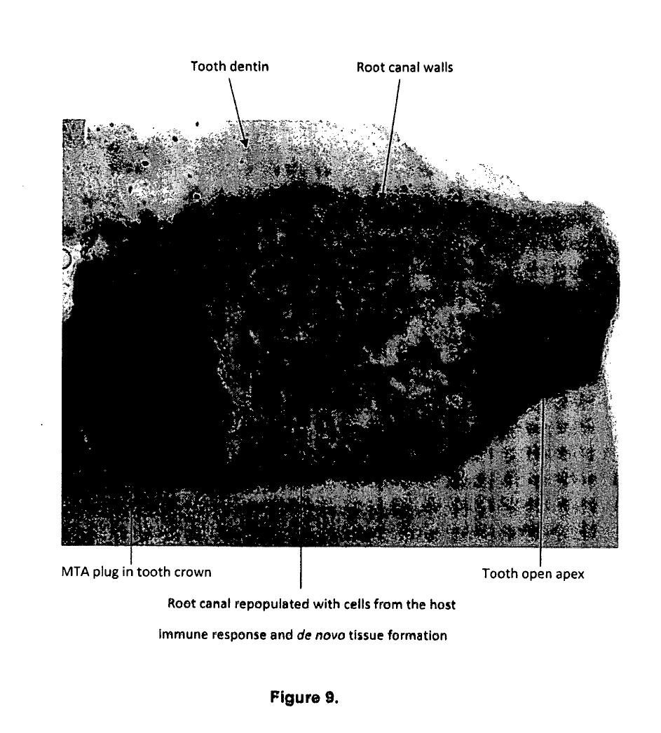

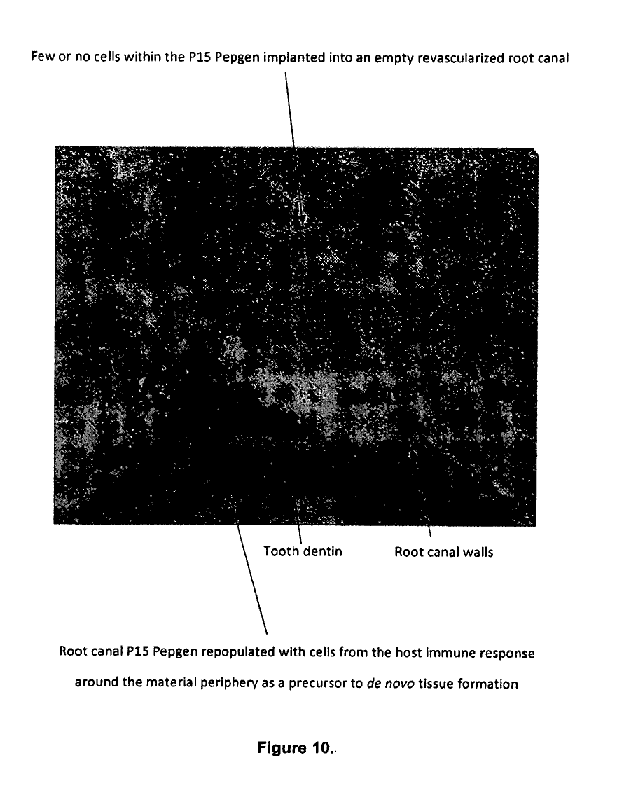

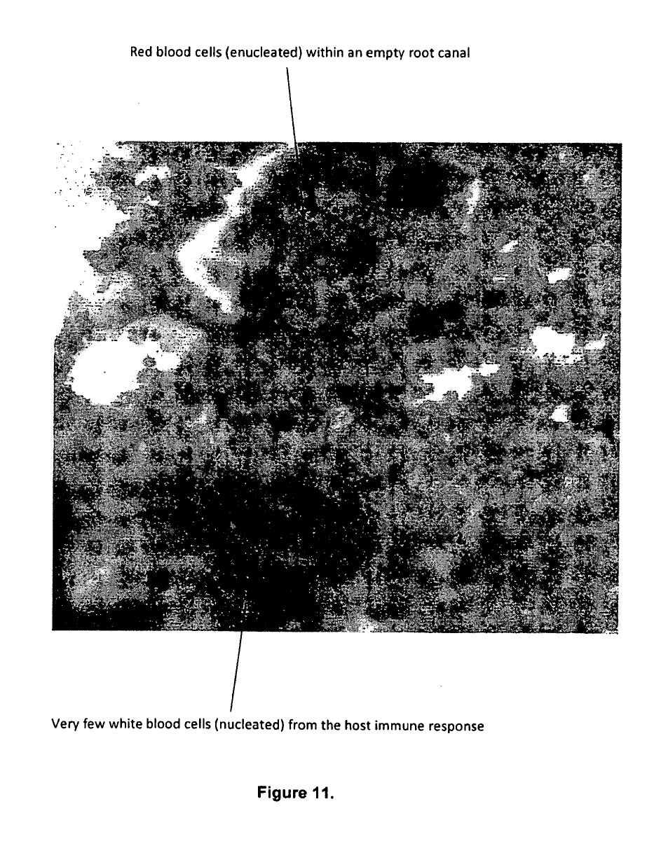

The numbers of cells repopulating the root canals of teeth delivered by the host immune response were highest where collagen tissue engineering scaffolds had been implanted (FIG. 9). Many red blood cells repopulated the root canals where no materials were added and a blood clot was permitted to fill the root canal space (FIG. 10). Some cells repopulated the space between the P15 Pepgen and the root canal walls, but none or few cells penetrated the material to repopulate the core of the root canals (FIG. 11). The highest numbers of cells repopulating the revascularized root canals following regenerative endodontic treatment A.

3.2. Cell Repopulation of Revascularized Root Canals

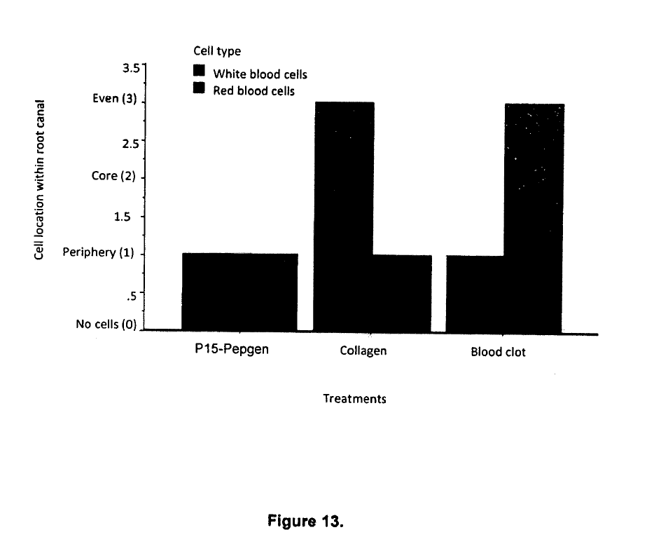

The locations of the host systemic white blood cells within the revascularized root canals following endodontic regeneration were evaluated as these are the precursor cells for tissue regeneration. In the regenerated root canals implanted with P15-Pepgen, very white and red blood cells were observed around the periphery of the scaffold (FIG. 13). The collagen scaffold had an even distribution of white blood, with red blood cells distributed around the periphery (FIG. 13). The blood clots which formed in the revascularized root canals mainly contained red blood cells, with some white blood cells around the periphery (FIG. 13).

Numerous modifications and variations of the present invention are possible in light of the above teachings. It is therefore to be understood that within the scope of the appended claims, the invention may be practiced otherwise that as specifically described herein.

What is claimed is:

1. A regenerative endodontic method comprising:
(a) removing unhealthy or infected dental pulp tissue from the root canal system;
(b) revascularizing the root canal system;
(c) inserting into the root canal system a scaffold, progenitor dental pulp cells, and growth factors, singly, or a combination thereof; and
(d) applying a post-operative sealant to the coronal and/or apical access to the root canal to help prevent infection.

2. The method of claim 1, wherein the scaffold is rigid.

3. The method of claim 1, wherein the scaffold is injectable.

4. The method of claim 1, wherein the revascularization is achieved by causing blood to flow into the root canal system by instrumenting or removing the apex.

5. The method of claim 1, wherein intracanal irrigating solutions and antibiotics are used to disinfect the root canal system and increase revascularization.

6. The method of claim 1, wherein the progenitor dental pulp cells are from autologous cells derived from a buccal mucosal biopsy.

7. The method of claim 1, wherein the progenitor dental pulp cells are derived from an allogenic purified pulp stem cell line that is expected to be disease and pathogen-free.

8. The method of claim 1, wherein the progenitor dental pulp cells are derived from xenogenic pulp stem cells that have been grown in the laboratory.

9. The method of claim 1, wherein the progenitor dental pulp cells are from autogenous cells derived from umbilical cord stem cells.

10. The method of claim 1, wherein the progenitor dental pulp cells are obtained from extracted or in situ deciduous or permanent teeth, and/or surrounding oral tissues.

11. The method of claim 1, wherein the progenitor dental pulp cells are organized into a three-dimensional scaffold that can support cell organization and vascularization.

12. The method of claim 1, wherein the three-dimensional scaffold is a porous polymer scaffold seeded with progenitor dental pulp cells to create a dental pulp construct.

13. The method of claim 1, wherein the scaffold further comprises nutrients for promoting cell survival and growth and antibiotics.

14. The method of claim 1, wherein the scaffold comprises dentin chips.

15. The method of claim 1, wherein the scaffold matrix comprises a polymer hydrogel.

16. An endodontic kit comprising an implantable scaffold matrix, a disinfecting solution, and isolated dental pulp cells.

17. The kit of claim 16, wherein the implantable scaffold matrix is a hydrogel.

18. The kit of claim 16, wherein the implantable scaffold matrix comprises a material selected from the group consisting of collagen, fibrin, chitosan, and glycosaminoglycans.

19. The kit of claim 16, wherein the implantable scaffold matrix comprises a material selected from the group consisting of polylactic acid, polyglycolic acid, and polycaprolactone.

20. The kit of claim 16, wherein the scaffold comprises an antibiotic.

21. The kit of claim 16, wherein the isolated dental pulp cells are stem cells.

22. The kit of claim 16, wherein the isolated dental pulp cells express at least one of the following: von Willebrand factor CD146, alpha-smooth muscle actin, and 3G5 proteins.

23. The kit of claim 16, further comprising an irrigating solution.

24. The kit of claim 16, further comprising an agent for cleaning the root canal selected from the group consisting of an acid and a chelating agent.

25. The kit of claim 16, further comprising an endodontic file.

26. The kit of claim 16, further comprising a cellular growth factor selected from the group consisting of a member of the transforming growth factor-beta family, a bone morphogenic protein, insulin-like growth factor-I or -II, Colony stimulating factor, Epidermal growth factor, Fibroblast growth factor, Insulin-like growth factor-I or II, Interleukins IL-1 to IL-13, Platelet-derived growth factor, and Nerve growth factor.

27. An endodontic kit comprising an implantable scaffold, matrix, a disinfecting solution, a cleaning solution, and an endodontic file.

28. The kit of claim 27, wherein the cleaning solution is an acid or a chelating agent.

29. The kit of claim 27, wherein the implantable scaffold matrix comprises a material selected from the group consisting of collagen, fibrin, chitosan, and glycosaminoglycans.

30. The kit of claim 27, wherein the implantable scaffold matrix comprises a material selected from the group consisting of polylactic acid, polyglycolic acid, and polycaprolactone.

31. The kit of claim 27, wherein the implantable scaffold matrix comprises an antibiotic.

32. The kit of claim 27, where the implantable scaffold matrix is platelet rich plasma, blood, or any blood serum product.
